(19) United States
(12) Patent Application Publication
(10) Pub. No.: US 2024/0250544 A1
(43) Pub. Date: Jul. 25, 2024

(54) PROVIDING POWER GRID SUPPORT WITH BATTERIES OF CHARGING POINTS FOR ELECTRIC VEHICLES

(71) Applicant: Inventus Holdings, LLC, Juno Beach, FL (US)

(72) Inventors: Rachana Vidhi, Palm Beach Gardens, FL (US); Jeffrey T. Plew, Pembroke Pines, FL (US)

(21) Appl. No.: 18/158,053

(22) Filed: Jan. 23, 2023

(51) Int. Cl. H02J 7/00; B60L 53/62; B60L 53/63; B60L 53/68; H02J 3/00

(52) U.S. Cl. CPC H02J 7/0071; B60L 53/62; B60L 53/63; B60L 53/68; H02J 3/003; H02J 7/0013; H02J 7/0048; B60L 53/67; B60L 2260/46

(57) ABSTRACT

A power needs engine predicts a peak recharge time interval for a charging points of charging stations based on state of charge (SoC) data for electric vehicles (EVs) that are within a threshold distance. The SoC data characterizes an SoC of batteries of the EVs. A charge control module creates and/or updates charging schedules for the charging points of the charging stations based on the charge time and the peak recharge time interval for the charging points of the charging stations. The charge control module also provides the charging schedules to computing platforms of the charging points of the charging stations. The computing platforms cause the batteries of the charging points to charge and discharge according to a corresponding charging schedule of the charging schedules.

### TECHNICAL FIELD

This disclosure relates to charging points for electric vehicles (EVs). More particularly, this disclosure relates to providing power grid support with batteries of charging points for EVs.

### BACKGROUND

An electric vehicle (EV), uses one or more electric motors or traction motors for propulsion. An EV may be powered through a collector system by electricity from off-vehicle sources, or may be self-contained with a battery, solar panels or an electric generator to convert fuel to electricity. EVs include, but are not limited to, road and rail vehicles, surface and underwater vessels, electric aircraft and electric spacecraft. An electric-vehicle battery (EVB) or traction battery is a battery used to power the propulsion of EVs. Vehicle batteries are usually a secondary (rechargeable) battery. Traction batteries are used in forklifts, electric golf carts, riding floor scrubbers, electric motorcycles, electric cars, trucks, vans, and other electric vehicles. A plug-in electric vehicle (PEV) is a motor vehicle that can be recharged from any external source of electricity, such as wall sockets, and the electricity stored in the rechargeable battery packs drives or contributes to drive the wheels. PEV is a subcategory of EVs that includes all-electric or battery electric vehicles (BEVs), plug-in hybrid vehicles, (PHEVs), and electric vehicle conversions of hybrid electric vehicles and conventional internal combustion engine vehicles.

An EV electric recharging point, also called a charging point, ECS (Electronic Charging Station) and EVSE (electric vehicle supply equipment), is an element in an infrastructure that supplies electric power for the recharging of EVs, such as plug-in EVs, including electric cars, neighborhood EVs and plug-in hybrids. At home or work, some EVs have onboard converters that can plug into a standard electrical outlet or a high-capacity appliance outlet.

### SUMMARY

One example relates to a non-transitory machine readable medium having machine executable instructions. The machine executable instructions include a power needs engine that predicts a peak recharge time interval for a charging points of charging stations based on state of charge (SoC) data for electric vehicles (EVs) that are within a threshold distance, wherein the SoC data characterizes an SoC of batteries of the EVs. The machine executable instructions also include a charge control module that creates and/or updates charging schedules for the charging points of the charging stations based on the charge time and the peak recharge time interval for the charging points of the charging stations. The charge control module also provides the charging schedules to computing platforms of the charging points of the charging stations. The computing platforms cause the batteries of the charging points to charge and discharge according to a corresponding charging schedule of the charging schedules.

Another example relates to a system for charging and discharging batteries. The system includes a charging server that predicts a peak recharge time interval for charging points of charging stations based on SoC data for EVs that are within a threshold distance, wherein the SoC data characterizes an SoC of batteries of the EVs. The charging server determines, in response to the prediction of the peak recharge time interval, a charge time for the charging points of the charging stations. The charge time defines a time to charge a respective battery of the charging points prior to the predicted peak recharge time interval. The charging server also creates and/or updates charging schedules for the charging points of the charging stations based on the charge time and the peak recharge time interval for the charging points of the charging stations. The computing platforms of the charging points of the charging stations receive a respective charging schedule of the charging schedules and determines, in response to the prediction of the peak recharge time interval characterized in the charging schedules, a charge time for the charging points of the charging stations, wherein the charge time defines a time to charge a respective battery of the charging points prior to the predicted peak recharge time interval. The computing platforms control operations of an inverter and an alternating current (AC) to direct current (DC) converter to charge and discharge a respective battery according to the respective charging schedule.

Yet another example relates to a method for charging and discharging batteries that includes predicting, by a charging server, a peak recharge time interval for charging points of charging stations based on SoC data for EVs that are within a threshold distance, wherein the SoC data characterizes an SoC of batteries of the EVs. The method also includes creating and/or updating, by the charging server, charging schedules for the charging points of the charging stations based on the charge time and the peak recharge time interval for the charging points of the charging stations. The method includes receiving, at computing platforms operating on the charging points of the charging stations, a respective charging schedule of the charging schedules. The method further includes determining, by the computing platforms, a charge time for the charging points of the charging stations based on corresponding predicted peak recharge time intervals for the charging stations characterized in the charging schedules. The charge time defines a time to charge a respective battery of the charging points prior to the predicted peak recharge time interval. The method yet further includes controlling, by the computing platforms, operations of the respective charging points to charge and discharge a respective battery according to the respective charging schedule.

### BRIEF DESCRIPTION OF THE DRAWINGS

FIG. 1 illustrates an example of a system that can intelligently control a charging and discharging of batteries of charging points for electric vehicles (EVs) to support a power grid and to curtail battery degradation.

FIG. 2 illustrates a graph of a charging cycle for a charging point of a charging station in a first example.

FIG. 3 illustrates a graph of a charging cycle for a charging point in a charging station in a second example.

FIG. 4 illustrates graphs of charging cycles for charging points of charging stations in a third example.

FIG. 5 illustrates a graph of a charging cycle for a charging point in a charging station in a fourth example.

FIG. 6 illustrates a flowchart of an example method for charging and discharging batteries of charging points of charging stations.

### DETAILED DESCRIPTION

This description relates to a system for controlling a state of charge (SoC) of a battery situated at a charging point of a charging station for electric vehicles (EVs). More specifically, the system selectively charges the battery of the charging point for EVs in anticipation of a peak recharge time interval. The system employs machine learning (ML) techniques to predict the peak recharge time interval, and recharges the battery prior to the predicted peak recharge time interval.

Charging stations include a plurality of charging points that are each employable to charge a respective EV. Charging stations face unpredictable charging loads. For instance, suppose that a given charging station includes 10 charging points for charging up to 10 EVs contemporaneously. In this situation, the given charging station has intervals of time (e.g., off-peak recharge time intervals) where there are 2 or less EVs being charged at one time. In other time intervals (e.g., peak recharge time intervals), 7-10 EVs may be charging concurrently. More specifically, in some examples, a peak recharge time interval occurs in situations where it is predicted that at least 70% of charging points at a particular charging station are expected to be concurrently coupled to a respective EV. In a conventional approach, due to limitations of the power grid, during these peak recharge time intervals, the charging station reduces an output current at the charging points, which in turn, increases a charging time for the EVs.

To overcome these limitations, batteries are added to the charging station to support the power grid. The system is configured to employ an ML model, namely a power model, to predict the peak recharge time intervals. Prior to a predicted peak recharge time interval, the system causes the batteries of the charging station to be charged. Thus, during the subsequent peak recharge time intervals, the batteries of the charging station support the power grid, obviating the need to upgrade the power grid to meet demands during such peak recharge time intervals.

The power model employed to predict the peak recharge time intervals can be trained and tuned with data characterizing the SoC of EVs within a threshold distance (e.g., 100 kilometers) of the charging station. As an example, an EV with an SoC of 10% that is within 10 kilometers of the charging station will have a greater probability of stopping to charge at the charging station than an EV with a SoC of 90%. Similarly, an EV with a SoC of 50% that is within 10 kilometers of the given charging station and 50 kilometers of another charging station might be assigned a 20% chance of stopping at the given charging station, and a 70% chance of stopping at the other charging station. Thus, taken in the aggregate, the SoC of the EVs is employable to predict the peak recharge time intervals.

Additionally, in some examples, the ML model can be trained or tuned with additional data characterizing driving habits of drivers of individual EVs. For instance, a first EV (driven by a first person), may have a habit of stopping and charging at the given charging station that is independent (or nearly independent) of the SoC of the vehicle. Additionally, the routes of the EVs are also considered. For instance, if the given charging station is situated along a route to a predetermine destination of an EV, that EV is more likely to stop for charging at the given station than another station, even in many situations where the other charging station is closer to the EV.

Further, during the off-peak recharge time intervals, the batteries of the charging station are employable to support the power grid for activities unrelated to the charging of EVs. For instance, during time intervals that the grid is operating at peak (or near peak) usage, the batteries of the charging stations are dischargeable to the power grid to avoid the need for operation of generators that consume fossil fuels. Additionally, in some situations, batteries of the charging points and batteries of the EVs themselves can also be temporarily discharged to the grid during grid events that typically last 2-3 minutes.

Further still, during some periods (e.g., days or weeks) certain charging stations may have significantly lower usage than other time periods. For instance, a particular charging station near a popular vacation area may have a low usage time period during off-season. In these situations, the power model can predict the low usage time period based on a past history of usage. During the low usage time period, the batteries of the charging points of the particular charging station may be discharged to curtail battery degradation, thereby extending the overall life of the batteries.

By employing the system described, the batteries of the charging points at the charging station can be leveraged to avoid an increase in charging time of the EVs during the peak recharge time intervals. Further, in some examples, the batteries of the charging station can be discharged to provide support for the power grid at peak usage times of the power grid and/or during a grid event (e.g., a transient or extended interval of time where an available power on the grid drops). Additionally, by discharging the batteries of the charging points during low usage time periods, instead of maintaining the batteries of the charging points of the charging station at a high SoC, an overall life of the batteries for the charging station is extended.

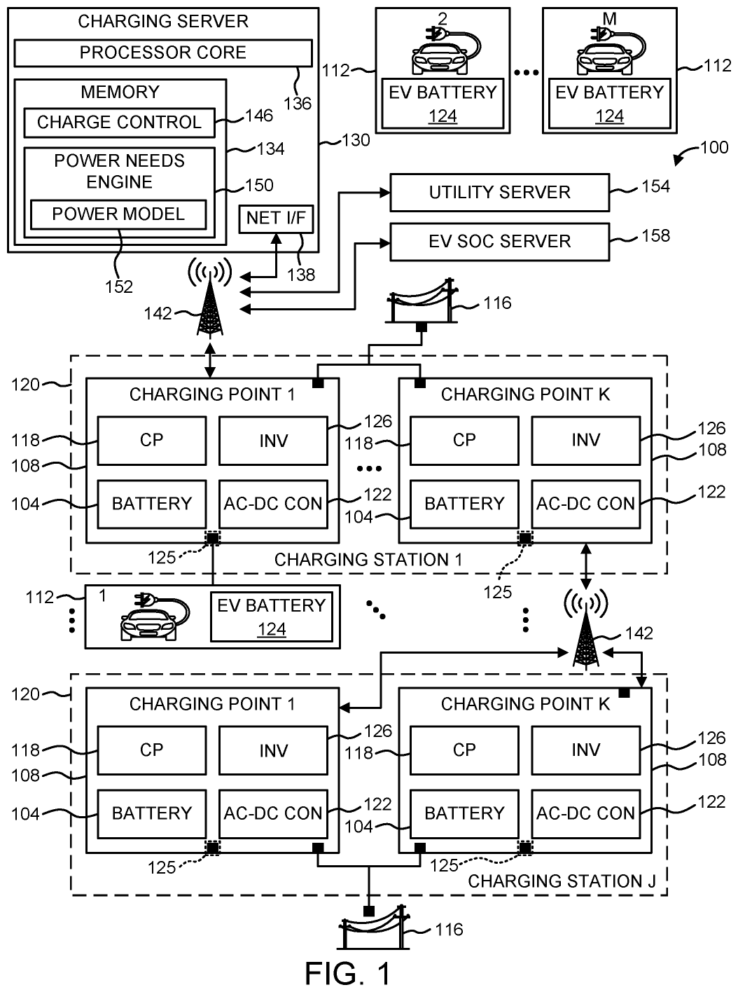

FIG. 1 illustrates an example of a system 100 that can intelligently control a charging and discharging of batteries 104 of charging points 108 for EVs 112 to support a power grid 116 and to curtail battery degradation. As used herein, an EV refers to a plug-in electric vehicle (PEV), namely an EV that can be plugged into an electrical receptacle (e.g., an electrical outlet), including a hybrid PEV. The system includes J number of charging stations 120 that each include K number of charging points 108, where J and K are integers greater than or equal to one. Additionally, different instances of the J number of charging stations 120 can have different (or the same) number of charging points 108.

As illustrated, each charging point 108 includes a battery 104. However, in some examples, a single battery 104 is shared amongst multiple charging points 108 of a particular charging station 120. Each charging point 108 is coupled to the power grid 116. In the example illustrated, two instances of the power grid 116 are illustrated, but in other examples, there could be more or less. Also, for purposes of simplification, it is presumed that the instances of the power grid 116 are coupled to a common point (e.g., a substation and/or a power generation station). Each charging point 108 also includes an alternative current (AC) to direct current (DC) converter 122. The AC-to-DC converter 122, alternatively referred to as a rectifier, converts AC power from the power grid 116 into DC power.

In the example illustrated, there are M number of EVs 112, where M is an integer greater than one. Each EV 112 includes an EV battery 124 that at least partially powers the EV 112. Intermittently, the EV battery 124 becomes depleted and needs recharged. Thus, an EV 112 with a depleted EV battery 124 can travel to one of the J number of charging stations 120 and connect to a particular charging point 108. In the example illustrated, the first EV 112 (EV 1) is coupled to the charging point 108 (charging point 1) of the first charging station 120 (charging station 1). More particularly, the first EV 112 is coupled to a charging port 125 of the charging point 108.

The charging points 108 include a computing platform 118. In some examples, the computing platform 118 of each charging point 108 is implemented as a controller (e.g., a processor core that executes embedded machine executable instructions). In other examples, the computing platform 118 of the charging points 108 is implemented with a non-transitory machine readable memory that stores machine executable instructions and a processor core (or multiple processor cores) that accesses the non-transitory memory and executes the machine executable instructions. In any such example, the computing platform 118 controls the operations of the corresponding charging point 108. In the example illustrated, each charging point 108 includes an individual computing platform 118. However, in some examples, other architectures are possible. For instance, in some examples, a single computing platform (e.g., an edge server) is deployed at a particular charging station and that single computing platform can control the K number of charging points.

As an example, responsive to the coupling, the computing platform 118 of the first charging point 108 causes the first charging point 108 to charge the EV battery 124 of the first EV 112. The computing platform 118 of the charging point 108 is configured to cause the converter 122 of the first charging point 108 to pull power from the power grid 116 to charge the EV battery 124. Additionally, the charging point 108 can supplement the power from the grid 116 with power from the battery 104 of the charging point 108. More particularly, the computing platform 118 can detect that a voltage (a DC voltage) output by the converter 122 of the charging point 108 is below a threshold level and boost the voltage output by the AC-to-DC converter 122 to the threshold level with power from the battery 104 of the first charging point 108 to maintain a particular rate of charge (e.g., a full rate of charge). In this manner, during intervals of time that the power grid 116 is outputting power at a peak level or near peak level, the rate of charge of the first EV 112 remains relatively constant.

Each charging point 108 also includes an inverter 126. Each inverter 126 is configured as a DC-to-AC converter that can convert power provided by the corresponding battery 104 to the power grid 116. The computing platform 118 can control the operations of the computing platform 118. In this manner, the batteries 104 of the charging points 108 can support the power grid 116. Stated differently, during certain events and/or time intervals (e.g., peak recharge time intervals or peak usage time intervals), some (or all) of the charging points 108 can discharge the batteries 104, and this discharged power is provided to the power grid 116 through the inverters 126.

The system 100 includes a charging server 130 (e.g., a computing platform) that supervises and controls the operation of the K number of charging points 108 at the J number of charging stations 120. The charging server 130 includes a non-transitory memory 134 that stores machine executable instructions. The non-transitory memory 134 could be implemented, for example, as non-transitory computer readable media, such as volatile memory (e.g., random access memory), nonvolatile memory (e.g., a hard disk drive, a solid state drive, flash memory, etc.) or a combination thereof. The charging server 130 also includes a processor core 136 (or multiple processor cores) that accesses the non-transitory memory 134 and executes the machine-executable instructions. The charging server 130 also includes a network interface 138 for communicating on a network 142. The network 142 could be implemented as a public network (e.g., the Internet), a private network (e.g., a cellular network) or a combination thereof (e.g., a virtual private network).

The charging server 130 could be implemented in a computing cloud. In such a situation, features of the charging server 130, such as the processor core 136, the network interface 138, and the memory 134 could be representative of a single instance of hardware or multiple instances of hardware with applications executing across the multiple of instances (i.e., distributed) of hardware (e.g., computers, routers, memory, processors, or a combination thereof). Alternatively, the non-transitory memory 134 could be implemented on a single dedicated server.

The computing platform 118 of the charging points 108 are also connected to the network 142. For illustrative purposes, there are multiple instances of the network 142, but it is presumed that nodes connected to the network 142 can communicate.

The non-transitory memory 134 includes a charge control module 146. The charge control module 146 is configured to provide and update a charging schedule to the computing platform 118 of K number of charging points 108 at the J number of charging stations 120. The charging schedule provided to the computing platform 118 of the K number of charging points 108 characterizes time intervals that the corresponding battery 104 is to be charged by the power grid 116 through the corresponding AC-to-DC converter 122 and/or discharged to the power grid 116 through the corresponding inverter 126. The charge control module 146 can also provide ad-hoc commands to the computing platform 118 of the K number of charging points 108 at the J number of charging stations 120.

The non-transitory memory 134 also includes a power needs engine 150 that determine when/if the schedules for the charging points 108 need to be updated. Additionally, the power needs engine 150 determines when/if an ad-hoc discharge of the batteries 104 is needed to support the power grid 116. In some examples, the power needs engine 150 is implemented as a machine learning (ML) algorithm engine, such as a neural network engine. Thus, the power needs engine 150 can interface with an ML model to extract data from the ML model and/or to tune the ML model. In particular, the power needs engine 150 includes a power model 152 that has been trained to predict the power needs of the M number of EVs 112 and the power needs of the power grid 116 as a function of time.

The system 100 includes a utility server 154 that communicates on the network 142. The utility server 154 provides power data characterizing power usage of the power grid 116 over time. In particular, the power data characterizes peak power usage time intervals. The power data is provided to the charge control module 146. The charge control module 146 analyzes the power data to determine if and when the charging points 108 should discharge power from the corresponding batteries 104 to the power grid 116.

The system 100 also includes an EV SoC server 158 that communicates on the network 142. The EV SoC server 158 provides SoC data for EVs 112 that are within a threshold distance (e.g., about 100 kilometers or about 60 miles) of a particular charging station 120 of the K number of charging stations 120. The SoC data includes a real time (e.g., within 10 minutes) location of the particular EV 112 and an SoC of the EV battery 124 for the particular EV 112.

More generally, the EV SoC server 158 is configured to monitor a location and an SoC of each of the M number of EVs 112. In some examples, the EVs 112 are equipped with a location tracking system, such as a global navigation satellite system (GNSS) that provides real time (e.g., within 10 minutes) location information for a corresponding EV 112. This location information is provided to the EV SoC server 158 along with a time stamped SoC of the EV battery 124. The EV SoC server 158 also has data characterizing a location of each of the K number of charging stations 120. Responsive to a particular EV 112 reaching the threshold distance, the EV SoC server 158 provides the SoC data characterizing this location information and the SoC of the EV battery 124 for the particular EV 112. Thus, over time, the EV SoC server 158 provides the SoC data for all (or a subset) of the M number of EVs 112.

The power needs engine 150 receives the SoC data for the M number of EVs 112 (or some subset thereof) and uses this SoC data to train and/or update the power model 152. The power model 152 employs the SoC data for the M number of EVs 112 to predict the peak recharge time intervals for each of the K number of charging stations 120. In some examples, the peak recharge time interval for a particular charging station 120 occurs in situations where it is predicted that at least 70% of charging points 108 at the particular charging station 120 are expected to be concurrently coupled to a respective EV 112. As an example, an EV with an SoC of 10% that is within 10 kilometers (e.g., about 6 miles) of a particular charging station 120 will have a greater probability of stopping to charge at the particular charging station 120 than an EV 112 with a SoC of 90%. Similarly, an EV 112 with a SoC of 50% that is within 10 kilometers (e.g., about 6 miles) of a first charging station 120 and 50 kilometers of a second charging station 120 might be assigned a 20% chance of stopping at the first charging station 120, and a 70% chance of stopping at the second charging station 120. Thus, taken in the aggregate, the SoC data characterizing the SoC of the EV battery 124 for the EVs 112 and the location information for the EV 112 is employable to predict the peak recharge time intervals for each of the charging stations 120.

Additionally, in some examples, the power model 152 can be trained and/or tuned with additional data characterizing driving habits of drivers of individual EVs 112. For instance, a first EV 112 (driven by a first person), may have a habit of stopping and charging at a particular charging station 120 that is independent (or nearly independent) of the SoC of the EV battery 124 of the first EV 112. Additionally, the routes of the EVs 112 are also considered. For instance, if a first charging station 120 is situated along a route to a predetermine destination of a particular EV 112 (e.g., a home of the driver of the particular EV 112), the particular EV 112 is more likely to stop for charging at the first charging station 120 than a second charging station 120 that is not along the route of the predetermined destination, even in some situations where the second charging station 120 is closer to the EV 112 than the first charging station 120.

Thus, over time, multiple instances of the SoC data for the M number of EV 112 enables the power model 152 to predict peak recharge time intervals and off-peak recharge time intervals for each of the charging stations 120. These peak recharge time intervals and off-peak recharge time intervals can be provided to the charge control module 146. The charge control module 146 employs this information to create and/or update a charging schedule for the batteries 104 of the charging points 108 of the K number of charging stations 120. Similarly, the charge control module 146 can employ the power data identifying peak power usage time intervals for the power grid 116 to create and/or update the charging schedule for the batteries 104 of the charging points 108 of the K number of charging stations 120.

The charging schedule for the charging points 108 of a particular charging station 120 provides a timetable to charge the batteries 104 of the K number of charging points 108 for the particular charging station 120. The charging schedule for the charging points 108 of the particular charging station 120 characterizes time intervals, such as the peak recharged time interval, the off-peak recharge interval, the peak usage time interval of the power grid 116, etc. The charging schedule for the particular charging station 120 ensures that the batteries 104 of the charging points 108 for the particular charging station 120 will be sufficiently charged prior to the peak recharge time interval for charging a subset of the M number of EVs 112. The charging schedule for the charging points 108 of the J number of charging stations 120 can also be based on the peak usage time interval for the power grid 116. The charging schedule for the particular charging station 120 ensures that the batteries 104 of the charging points 108 for the particular charging station 120 will be sufficiently charged prior to the peak usage time interval of the power grid 116.

In response to receipt of the charging schedule, the computing platform 118 determines a charging start time for the corresponding battery 104 of a particular charging point 108. The charging start time for the corresponding battery 104 is based on a current SoC of the battery and the peak recharge time interval for charging the M number of EVs 112 and/or the peak usage time interval for the power grid 116. As an extended first example (hereinafter, “the first example”), suppose that a peak recharge time interval for the first charging station 120 is at 5:45 p.m. local time, and that the peak recharge time interval ends at 7:30 p.m. local time. Additionally, in the first example, suppose that the first charging point 108 of the first charging station 120 has a battery 104 with a default SoC of about 20%. Further, in the first example, suppose that the battery 104 of the first charging point 108 charges at a rate of about 1% per minute, and that it is desirable to have the battery 104 at an SoC of about 100% at the start of the peak recharge time interval for the first charging station 120. Thus, in the first example, the computing platform 118 of the first charging point 108 in the first charging station 120 sets the charge time to about 80 minutes prior to the peak recharge time interval (5:45 p.m. in the first example). Thus, in the first example, at 4:25 p.m. local time (the charge time), the computing platform 118 controls the AC-to-DC converter 122 to charge the battery 104 in anticipation of the peak recharge time interval for the EV charging. Throughout a given day, there could be multiple peak recharge time intervals for charging the EVs.

Continuing with the first example, presume that there are 10 charging points 108 in the first charging station 120. In the first example, it is also presumed that at or near the peak recharge time interval, the power model 152 predicts that 9 EVs 112 approach the first charging station 120 and couple a EV battery 124 to the charging port 125 of a subset (or a full set) of the K number of charging points 108 of the first charging station 120. That is, during the peak recharge time interval, it is expected that 9 EVs will be drawing power concurrently. Due to the amount of power the K number of charging points 108 (10 charging points 108 in the first example) of the first charging station 120 draw to charge the EV battery 124 of the subset of EVs 112 (9 EVs in the first example), the power grid 116 may not provide instantaneous power to keep up with demand to maintain a full rate of charge at the charging points 108. However, rather than dropping a rate of charge for the EV batteries 124, the computing platform 118 of each respective charging point 108 monitors for a drop in an output power of the AC-to-DC converter 122. If such a drop is detected, the computing platform 118 causes the corresponding battery 104 of a particular charging point 108 to discharge and supplement the output power of the AC-to-DC converter 122 to maintain a full rate of charge (or nearly so). Accordingly, by determining the charging schedule for the charging points 108 in this manner, expensive upgrades to the power grid 116 are obviated while a full rate of charge is maintained. Stated differently, even during peak recharge time intervals, inclusion of the batteries 104 and ensuring that the batteries 104 are charged prior to the peak recharge time intervals enables the charging stations 120 to be fully leveraged (e.g., provide a full rate of charge for each charging point 108) without requiring an upgrade to the power grid 116 to support these peak recharge time intervals.

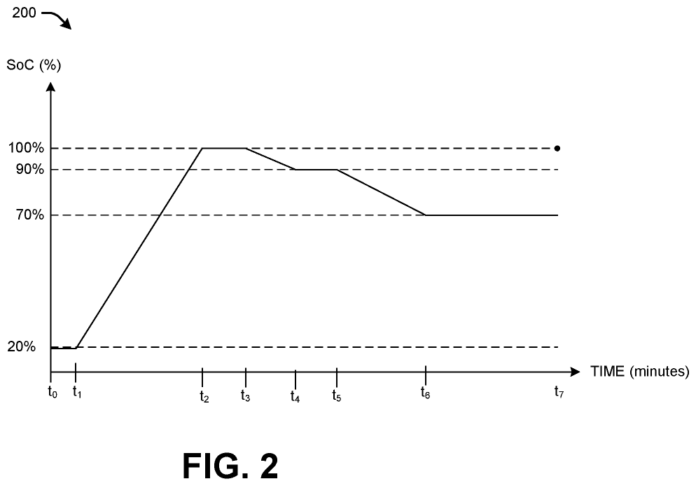

FIG. 2 illustrates a graph 200 of a charging cycle for the first charging point 108 in the first charging station 120 in the first example. The graph 200 plots a state of charge (SoC) of the battery 104 of the first charging point 108 in the first charging station 120 as a function of time.

In the graph 200, an initial time, t₀, it is presumed to be 4:00 p.m. local time, in the first example. As noted, it is presumed that the initial SoC for the battery 104 of the first charging point 108 in the first charging station 120 is at the default SoC of 20%. A time, t₁ is presumed to be a charge time, specifically, 4:25 p.m. local time in the first example. As illustrated, the SoC for the he battery 104 increases from 20% to 100% between the charge time, t₁ and the start of the peak recharge time interval, t₂, which is specified to be 5:45 in the first example.

In the graph 200, at time, t₃, (e.g., 6:00 p.m. local time in the first example) it is presumed that a first EV 112, such as the first EV 112 of the M number of EVs 112 of FIG. 1, is coupled to the first charging point 108 in the first charging station 120, and a time, t₄ (e.g., 6:15 p.m. local time in the first example), the first EV 112 completes charging and is decoupled from the first charging point 108. As illustrated, between times, t₃ and t₄, the battery 104 discharges from 100% to 90% to supplement the power grid 116 in the charging of the first EV 112.

Also, in the graph 200, it is presumed that from the times, t₄ to t₅ (e.g., 6:30 p.m. local time, in the first example), the SoC of the battery 104 remains relatively constant. At time, t₅, it is presumed that a second EV 112 is coupled to the first charging point 108 in the first charging station 120, and a time, t₆ (e.g., 7:00 p.m. local time, in the first example), the second EV 112 has completed charging, and is decoupled from the first charging point 108 in the first charging station 120. During the time interval between times t₅ and t₆, the battery 104 discharges from an SoC of 90% to an SoC of 70% to supplement the power grid 116 in the charging of the second EV 112. The SoC of the battery remains relatively constant from time, t₆ to time, t₇, which is presumed to be 7:30 p.m. local time in the first example, which is the end of the peak recharge time interval.

Referring back to FIG. 1, periodically and/or asynchronously, the computing platforms 118 can upload charge history data to the power needs engine 150 as feedback. The charge history data characterizes a number and duration that EVs are charged for a particular interval of time. The power needs engine 150 can employ this charge history data to tune the power model 152 improve the accuracy of the predictions made by the power model 152. In particular, this charge history data is employable to improve predictions of behaviors of the EVs 112 over time.

Also, during the off-peak recharge time intervals, the batteries 104 of the charging points 108 are employable to support the power grid 116 for activities unrelated to the charging of the M number of EVs 112. For instance, consider a second extended example (“the second example”), wherein during time intervals that the power grid 116 is operating at peak (or near peak) usage, the batteries 104 of the charging stations 120 are dischargeable to the power grid 116 to avoid the need for operation of supplemental generators that consume fossil fuels, thereby improving the performance of the charging stations 120 without an increase of output at the power grid 116.

In the second example, suppose that the utility server 154 provides power data to the charge control module 146 indicating that a peak usage time interval for the power grid 116 begins at 8:30 a.m. local time, which is presumed to be an off-peak recharge time interval for charging of the EVs 112. In the second example, the charging schedule for the first charging point 108 of the first charging station 120 provided by the charge control module 146 indicates that at 8:30 a.m. local time that the power grid 116 needs support until 11:00 a.m. local time. Thus, in response to such a charging schedule, at 8:30 a.m., the computing platform 118 causes the battery 104 of the first charging point 108 in the first charging station 120 to discharge at 8:30 a.m. (e.g., a discharge time) through the inverter 126 and provide power to the power grid 116. After the peak usage time interval has ended (11:00 a.m. local time in the second example), the battery 104 for the first charging point 108 of the first charging station 120 is charged to the default SoC if the battery 104 is below the default SoC. In the aggregate, the K number of charging points 108 at the J number of charging stations 120 can provide power to the power grid 116 at peak usage time intervals. In some examples, this extra power can curtail the need for the burning of fossil fuels at supplemental power generators of a power station coupled to the power grid 116. More particularly, in many instances, power grids (including the power grid 116) are designed such that fossil fuel burning generators (e.g., supplemental generators) are activated during peak grid usage times to avoid brown out. Discharging the batteries 104 of the K number of charging points 108 at the J number of charging stations 120 can reduce reliance on such supplemental burning of fossil fuels during these peak grid usage time intervals, thereby improving the performance of the power grid 116.

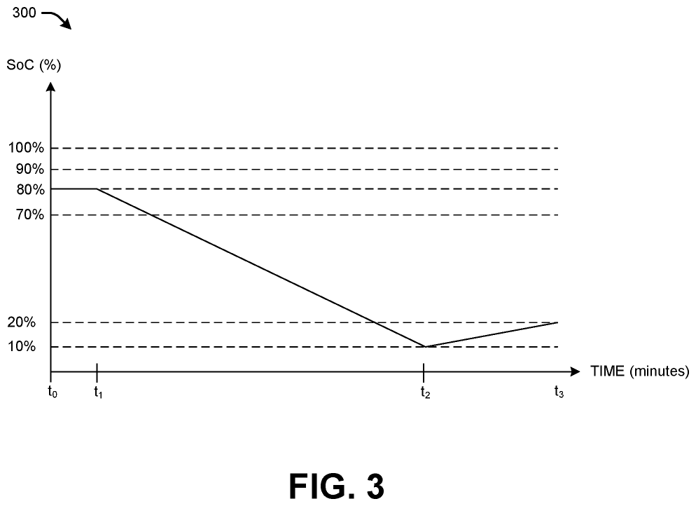

FIG. 3 illustrates a graph 300 of a charging cycle for the first charging point 108 in the first charging station 120 in the second example. The graph 300 plots a state of charge (SoC) of the battery 104 of the first charging point 108 in the first charging station 120 as a function of time.

In the graph 300, an initial time, t₀, is presumed to be 8:00 a.m. local time, in the second example. It is presumed that the initial SoC for the battery 104 of the first charging point 108 in the first charging station 120 is 80% at t₀. A time, t₁ is presumed to be a discharge time, specifically, 8:30 a.m. local time in the second example. As illustrated, the SoC for the he battery 104 decreases from 80% to 10% between the start of the peak usage time interval, t₁ and the end of the peak usage time interval, t₂, which is specified to be 11:00 a.m. in the first example. At time, t₂, the battery 104 is charged to the default SoC of 20%, and it is presumed that the charging of the battery 104 ceases at time, t₃ (e.g., about 11:45 a.m. local in the second example).

Referring back to FIG. 1, intermittently, the utility server 154 may report a grid event to the charge control module 146. As used herein, a grid event refers to a transient (e.g., temporary) unexpected drop in available power at a power grid, such as the power grid 116. A grid event lasts about 2 to 5 minutes. Also, grid events may be caused by physically damaged equipment, such that grid events are inherently unpredictable.

In response to receiving a notification of a grid event, the charge control module 146 can be configured to send ad-hoc commands (e.g., commands outside the charging schedule) to the K number of charging points 108 of the J number of charging stations 120, or some subset thereof to provide power to the power grid 116 for a duration of the grid event.

Consider a third extended example (hereinafter, “the third example”), where the charge control module 146 receives a notification from the utility server 154 that a grid event has been detected. Responsive to the grid event, the charge control module 146 can provide a discharge command to the K number of charging points 108 of a particular charging station 120 (or multiple charging stations) to provide support to the power grid 116 for an interval of time. In some examples, the charge control module 146 can provide such ad-hoc commands in a round-robin order. For instance, continuing with the third example, suppose that the charge control module 146 provides a command to the K number of charging points 108 at the first charging station 120 to provide support to the power grid 116 for a first interval of 30 seconds. Also continuing with the third example, suppose that the charge control module 146 provides a discharge command to the K number of charging points 108 at the second charging station 120 to provide support to the power grid 116 for a second interval of 30 seconds (immediately following the first interval of 30 seconds). This process is continued until the charge control module 146 receives an indication from the utility server 154 that the grid event has been resolved. Stated differently, the charge control module 146 provides the discharge commands in the round-robin order for the duration of the grid event.

Responsive to the discharge command, the computing platform 118 of a particular charging point 108 can cause the corresponding battery 104 to immediately (or nearly so) discharge power to the power grid 116 through the inverter 126 for the interval dictated by the discharge command. Additionally, in some situations, the power grid 116 can control the charging port 125 such that the EV battery 124 of the EVs 112 (coupled to the charging points 108) can also be discharge to the power grid 116 during the interval dictated by the discharge command. Continuing with the third example, suppose that the first EV 112 is coupled to the first charging point 108 of the first charging station 120 when the computing platform 118 of the first charging point 108 receives the discharge command. In the second example, responsive to the discharge command, the computing platform 118 of the first charging point 108 of the first charging station 120 causes the battery 104 and the EV battery 124 to discharge to the power grid 116 through the inverter 126 of the first charging point 108 for the first 30 second interval (selected by the charge control module 146). After this interval, the computing platform 118 ceases providing support to the power grid 116, and re-charging of the EV battery 124 of the first EV 112 is resumed or delayed until the grid event is resolved. Similarly, in the second example, suppose that the Kth charging point 108 of the Kth charging station 120 receives a discharge command for the second 30 second interval when no EV is coupled to the Kth charging point 108. Responsive to this discharge command, the Kth charging point causes the battery 104 to discharge to the power grid 116 through the corresponding inverter 126 during the second 30 second interval. After the second 30 second interval has tolled, the computing platform 118 of the Kth charging point 108 ceases discharging of the corresponding battery 104.

As demonstrated in the third example, by sending discharge commands to the charging points 108 of the J number of charging stations 120 on a round robin (rotating) discharge command, the inconvenience of delayed charging of the EV battery 124 of coupled EVs 112 is curtailed. Stated differently, by limiting the grid support for each charging station 120 to a particular interval (e.g., a 30 second interval), the time costs associated with providing grid support during the grid event is distributed to the J number of charging stations 120.

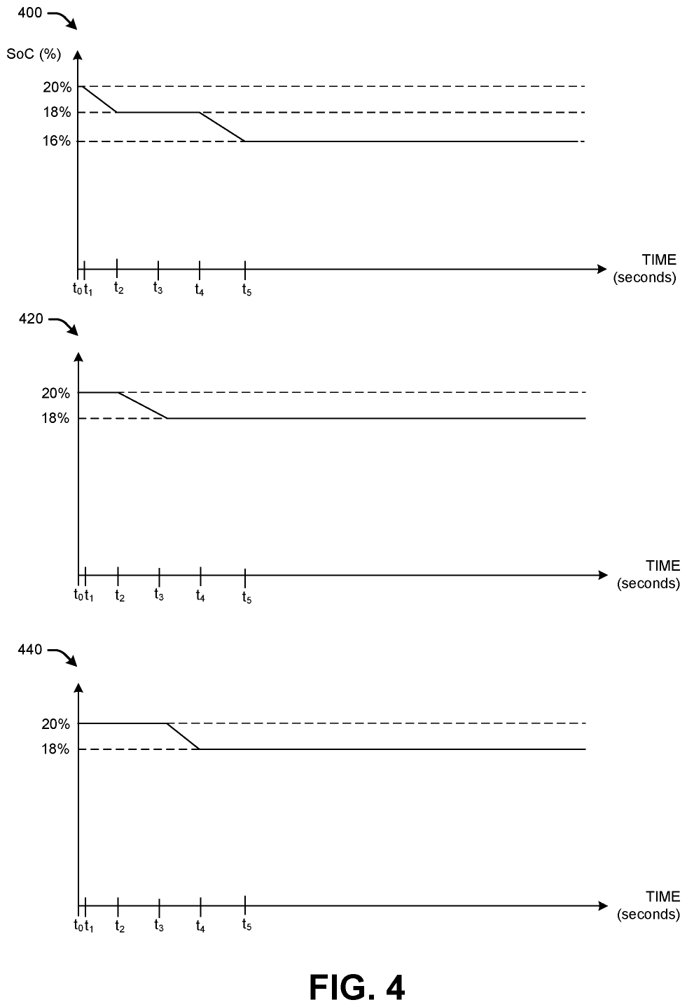

FIG. 4 illustrates graphs of charging cycles for charging points 108 of charging stations 120 in the third example. More specifically, FIG. 4 illustrates a first graph 400 of a charging cycle for the first charging point 108 in the first charging station 120 in the first example. FIG. 4 also illustrates a second graph 420 of a charging cycle for the second charging point 108 in the second charging station 120 in the third example. FIG. 4 also illustrates a third graph 440 of a charging cycle for the third charging point 108 in the third charging station 120 in the third example. The graphs 400, 420 and 440 plot a state of charge (SoC) of the corresponding battery 104 of the charging points 108 as a function of time. The graphs 400, 420 and 440 are plotted on the same time scale to establish continuity.

At time, t₀, the batteries 104 of the charging points 108 are each at the default SoC of 20%. As illustrated in the graph 400, at a time, t₁, a grid event occurs, and the first charging point 108 of the first charging point discharges to support the power grid 116 during the grid event. Between time, t₁ and time, t₂ (e.g., about 30 seconds in the third example), the battery 104 of the first charging point 108 discharges from 20% to 18% to the power grid 116. Additionally, between times, t₂ and t₄, the battery 104 of the first charging point 108 remains relatively constant.

As illustrated in the graph 420, from time, t₀ to time, t₂ (e.g., about 30 seconds after time, t₁), the battery 104 of the second charging point 108 remains relatively constant. Also, at time, t₂, the battery 104 of the second charging point 108 discharges to the power grid 116 during the grid event until time, t₃, which is about 30 second after time, t₂ in the third example. From time, t₃ onward, the SoC of the battery 104 of the second charging point 108 remains relatively constant.

As illustrated in the graph 440, from time, t₁ to time, t₃ (e.g., about 60 seconds after time, t₁), the battery 104 of the third charging point 108 remains relatively constant. Also, at time, t₃, the battery 104 of the third charging point 108 discharges to the power grid 116 during the grid event until time, t₄, which is about 30 second after time, t₃ in the third example. From time, t₄ onward, the SoC of the battery 104 of the third charging point 108 remains relatively constant.

Further, in the graph 400, from time, t₄ to time, t₅ (about 30 seconds after time, t₄), the battery of the first charging point 108 discharges to the power grid 116 during the grid event. From time, t₅ onward, the SoC of the battery 104 of the third charging point 108 remains relatively constant. It is presumed in the third example that at time, t₅, the grid event is resolved, and no further support for the power grid 116 related to the grid event is needed. Thus, as illustrated in FIG. 4, the batteries of the first charging point 108 on the first charging station 120, the second charging point 108 of the second charging station 120 and the third charging point 108 on the third charging station 120 are discharged in a round-robin order to support the power grid 116 during the grid event.

Referring back to FIG. 1, as explained with the second example and the third example, the battery 104 of each of the K number of charging points in each of the K number of charging stations 120 (or some subset thereof) can be leveraged to support the power grid 116 in ways outside of supporting the charging of the EVs 112. Accordingly, over time, the charge control module 146 can collect the SoC data characterizing a current SoC of corresponding batteries 104. The charge control module 146 can provide this SoC data to the power needs engine 150. The power needs engine 150 can provide this SoC data to the power model 150 to predict a total available energy for the power grid 116 from the batteries 104 on the charging points 108 of the charging stations 120 as a function of time. The prediction of the total available energy as a function of time can be based on an expected traffic of the EVs 112. Stated differently, the prediction of the total available energy as a function of time is based on the SoC data and the predicted peak recharge time for the K number of charge points 108 of the J number of charging stations 120. This information can be provided from the power needs engine 150 to the utility server 154.

The utility server 154 can leverage the prediction of the total energy available for the power grid 116 as a function of time to improve reliability of the power grid 116. In particular, the prediction of the total energy available for the power grid 116 can be employed to improve the accuracy of availability of additional power resources to meet reliability needs of the power grid 116. This information can be used by a scheduler to curtail the operation of other resources with relatively high green house gas (GHG) emissions.

Further, in some examples, the power model 152 can predict a low usage time period for a subset (or all) of the J number of charging stations 120. In a fourth example, (hereinafter, “the fourth example”) suppose that the first charging station 120 is located proximate to a university. Thus, during certain time periods (e.g., during fall and spring semesters), the first charging station 120 has regular peak recharge time intervals throughout a given day. However, during certain periods of time (e.g., winter break or summer break), usage of the K number of charging points 108 at the first charging station 120 drops off considerably. In these situations, the power needs engine 150 can provide the charge control module 146 with data characterizing a low usage time period. For instance, in the fourth example, it is presumed that 12:00 a.m. local time on December 13 to 12:00 a.m. local time January 9 (e.g., winter break) is a low usage time interval. In the fourth example, suppose that during the low usage time interval, the power model 152 predicts that 2 or less EVs 112 will be charging at the first charging station 120 at any given time. Thus, the charge control module 146 can create and/or update the charging schedule for the charging points 108 of the first charging station 120 to add the low usage time period.

Responsive to determining that a particular charging point 108 is in a low usage time period, the computing platform 118 of the particular charging point 108 can cause the corresponding battery 104 to discharge to the power grid 116 to avoid battery overuse. More particularly, in the fourth example, the computing platform 118 causes the corresponding charging points 108 to discharge to a threshold charge level or below until the low usage period of time has expired. In some examples, the battery 104 is a lithium ion battery, and in these examples the threshold charge level is a state of charge (SoC) of about 50% or less. Discharging the corresponding battery 104 to the threshold charge level reduces a percentage of time that the corresponding battery is at an SoC greater than the threshold charge level. During time intervals that the corresponding battery 104 exceeds the threshold charge level, the total energy density (e.g., a total amount of charge) of the corresponding battery 104 reduces. Thus, by curtailing the amount of time that the corresponding battery 104 is above the threshold charge level, the overall lifetime of the corresponding battery 104 is increased.

Further, during the low usage time period, the charge control module 146 can still request support for the power grid 116. More particularly, during the low usage time period, the power model 152 could indicate that the power grid 116 has periodic and/or asynchronous peak usage time intervals. Responsive to these indications, the charge control module 146 can create and/or update the charging schedule for the charging points 108 of the first charging station 120 to support the power grid 116 during peak usage interval that are contemporaneous with the low usage time period.

Responsive to determining that a particular charging point 108 is to support the power grid 116 in a low usage time period, the computing platform 118 of the particular charging point 108 can cause the corresponding battery 104 to charge to the threshold charge level and discharge to the power grid 116 to provide support for the power grid 116. In this manner, support for the power grid 116 is provided without impacting the total charge density of the corresponding battery 104.

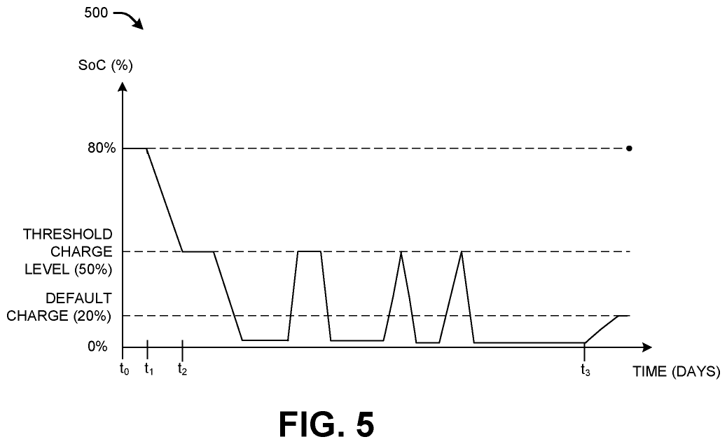

FIG. 5 illustrates a graph 500 of a charging cycle for the first charging point 108 in the first charging station 120 in the fourth example. The graph 300 plots a state of charge (SoC) of the battery 104 of the first charging point 108 in the first charging station 120 as a function of time (in days).

In the graph 500, an initial time, t₀, is presumed to be 8:00 a.m. local time, in the fourth example. It is presumed that the initial SoC for the battery 104 of the first charging point 108 in the first charging station 120 is 80% at t₀. A time, t₁ is presumed to a start of a low usage time period, specifically, 12:00 a.m. local time on December 13 in the fourth example. As illustrated, the SoC for the he battery 104 decreases from 80% to 50% (the threshold charge level) between the start of the low usage time period, t₁ and time, t₂. From time, t₂ to time, t₃, the battery 104 is employed to support the power grid 116. During this time interval, the battery 104 is charged and discharged multiple times (based on the peak usage time intervals of the power grid 116). At time, t₃, it is presumed that the low usage time period has ended. In the fourth example, the time, t₃ represents 12:00 a.m. local time on January 9. Also, at time, t₃, the battery 104 is charged to the default SoC of 20%.

As demonstrated in the graph 400, the battery 104 of the first charging point 108 of the first charging station 120 maintains a SoC that does not exceed the threshold charge level of 50% over the low usage time period (e.g., the time period between times t₂ and t₃). Thus, the impact on the total energy density of the battery 104 is curtailed.

As demonstrated, by controlling the schedule for charging and discharging of the batteries 104 of the K number of charging points 108 of the J number of charging stations 120, power is distributed in a manner that improves the performance of the power grid 116 without requiring an upgrade to the power grid 116. Also, by selectively discharging the batteries 104 during the low usage periods, the overall lifetime of such batteries is extended.

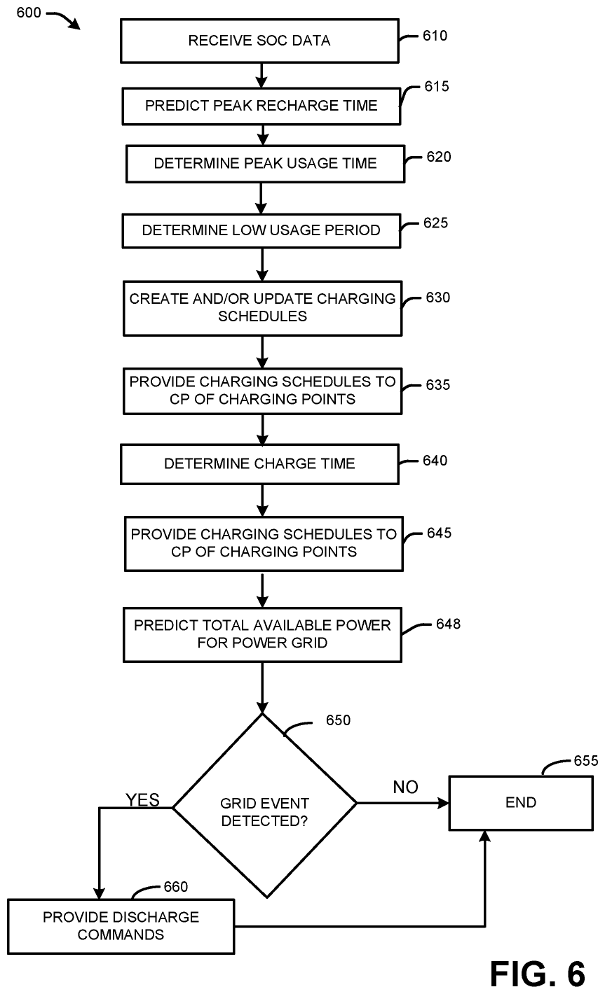

In view of the foregoing structural and functional features described above, an example method will be better appreciated with reference to FIG. 6. While, for purposes of simplicity of explanation, the example method of FIG. 6 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method.

FIG. 6 illustrates a flowchart of an example method 600 for charging and discharging batteries of charging points of charging stations, such as the batteries 104 of FIG. 1. The method 600 can be executed by the system 100 of FIG. 1. At 610, a power needs engine (e.g., the power needs engine 150 of FIG. 1) executing on a charging server (e.g., the charging server 130 of FIG. 1) receives SoC data for a plurality of EVs (e.g., the M number of Evs 112 of FIG. 1). The SoC data is employable to train and/or tune an ML model, such as the power model 152 of FIG. 1.

At 615, the power needs engine predicts a peak recharge time interval for a charging points of charging stations based on the SoC data for the plurality of Evs that are within a threshold distance. The SoC data characterizes an SoC of batteries of the Evs. Additionally, the SoC data can include information characterizing a current location and/or a route of the Evs. As one example, the peak recharge time interval for a particular charging station of the plurality of charging stations is a time interval where at least 75% of charging points at the particular charging station are expected to be coupled to a respective EV of the Evs. Moreover, the prediction of the peak recharge time interval for the particular charging station of the charging stations is based on a calculated likelihood that a subset of the Evs will recharge at the particular charging station.

At 620, a charge control module (e.g., the charge control module 146) executing on the charging server determines a peak usage time interval for a power grid based on power data provided from a utility server (e.g., the utility server 154 of FIG. 1). At 625, the power needs engine determines a low usage period (if any) for the charging stations.

At 630, a charge control module (e.g., the charge control module 146) executing on the charging server creates and/or updates charging schedules for the charging points of the charging stations. At 635, the charging schedules are provided to computing platforms operating on the charging points of the charging stations. At 640, the computing platforms determine a charge time for the charging points of the charging stations based on corresponding peak recharge time intervals for the charging stations. The charge time defines a time to charge a respective battery of the charging points prior to the predicted peak recharge time interval. At 645, the computing platforms control operations of the respective charging points to charge and discharge a respective battery according to the respective charging schedule.

At 648, the power needs engine predicts a total available power for the power grid as a function of time. This prediction can be based on the SoC of the batteries of the charging points over time, as well as a prediction of the charging needs of the EVs (e.g., the predicted peak recharge time). The total amount of power for the power grid characterizes an amount of power dischargeable to the power grid as a function of time. The prediction of the total available power for the power grid as a function of time is provided to the utility server. A scheduler of the utility server can employ this information to curtail the use of power resources with a greater GHG, such that the reliability of the power grid is improved.

At 650, a determination is made by the charge control module as to whether a grid event is detected (e.g., in response to data from the utility server). If the determination at 650 is negative (e.g., NO), the method 600 proceeds to 655. If the determination at 650 is positive (e.g., YES), the method 600 proceeds to 660. At 655, the method 600 ends. Also, in some examples, the method 600 returns to 610. At 660, the charge control module provides discharge commands to the charging points of the charging stations in a round robin order, and the method proceeds to 655. Responsive to the discharge commands, the computing platforms cause the corresponding batteries to discharge to the power grid to support the power grid during the grid event.

In view of the foregoing structural and functional description, those skilled in the art will appreciate that portions of the systems and method disclosed herein may be embodied as a method, data processing system, or computer program product such as a non-transitory computer readable medium. Accordingly, these portions of the approach disclosed herein may take the form of an entirely hardware embodiment, an entirely software embodiment (e.g., in a non-transitory machine readable medium), or an embodiment combining software and hardware. Furthermore, portions of the systems and method disclosed herein may be a computer program product on a computer-usable storage medium having computer readable program code on the medium. Any suitable computer-readable medium may be utilized including, but not limited to, static and dynamic storage devices, hard disks, optical storage devices, and magnetic storage devices.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processors of a general purpose computer, special purpose computer, or other programmable data processing apparatus (or a combination of devices and circuits) to produce a machine, such that the instructions, which execute via the one or more processors, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

What have been described above are examples. It is, of course, not possible to describe every conceivable combination of structures, components, or methods, but one of ordinary skill in the art will recognize that many further combinations and permutations are possible. Accordingly, the invention is intended to embrace all such alterations, modifications, and variations that fall within the scope of this application, including the appended claims. Where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A non-transitory machine readable medium having machine executable instructions comprising:
a power needs engine that:
predicts a peak recharge time interval for a charging points of charging stations based on state of charge (SoC) data for electric vehicles (EVs) that are within a threshold distance, wherein the SoC data characterizes an SoC of batteries of the EVs; and
a charge control module that:
creates and/or updates charging schedules for the charging points of the charging stations based on the charge time and the peak recharge time interval for the charging points of the charging stations; and
provides the charging schedules to computing platforms of the charging points of the charging stations, wherein the computing platforms cause the batteries of the charging points to charge and discharge according to a corresponding charging schedule of the charging schedules.

2. The medium of claim 1, wherein the peak recharge time interval for a particular charging station of the charging stations is a time interval where at least 70% of charging points at the particular charging station are expected to be coupled to a respective EV of the EVs.

3. The medium of claim 1, wherein the power needs engine comprises a machine learning (ML) model tuned with the SoC data.

4. The medium of claim 3, wherein the prediction of the peak recharge time interval for a particular charging station of the charging stations is based on a calculated likelihood that a subset of the EVs will recharge at the particular charging station.

5. The medium of claim 4, wherein the likelihood that the subset of the EVs will recharge at the particular charging station is based on data characterizing driving habits of drivers of the EVs.

6. The medium of claim 4, wherein the SoC data includes data characterizing a location of the EVs.

7. The medium of claim 6, wherein the SoC data includes data characterizing a route for a subset of the EVs.

8. The medium of claim 2, wherein the charge control module receives power data identifying a peak usage time interval for a power grid, and responsive to the power data the charge control module updates and/or creates the charge control schedules based on the peak usage time interval of the power grid such that the computing platforms of the charging points are configured to cause the corresponding batteries to discharge to the power grid during time intervals that are off-peak recharge time intervals and the peak usage time interval.

9. The medium of claim 8, wherein the charge control module receives an indication of a grid event, and responsive to the grid event, the charge control module provides a discharge command to the computing platforms of the charging stations to support the power grid for a duration of the grid event.

10. The medium of claim 9, wherein the charge control module provides the discharge commands to the computing platforms of the charging points of the charging stations in a round-robin order, such that each charging point in a first charging station of the charging stations is provided the discharge command prior to providing the discharge commands to each charging point in a second charging station of the charging stations.

11. The medium of claim 10, wherein responsive to the discharge commands, the computing platforms of the charging points cause the corresponding battery and an EV battery to discharge to the grid for a duration specified in the discharge commands.

12. The medium of claim 1, wherein the power needs engine predicts a low usage time period for a particular charging station, and the charge control module creates and/or updates a respective charging schedule of the charging schedules based on the low usage period of time, and a computing platform of charging points of the particular charging station causes a corresponding battery to discharge to at or below a threshold charge level until the low usage period of time has expired, wherein the charging schedule for the charging points of a particular charging station of the charging stations specifies a schedule to charge and discharge the corresponding batteries of the charging points based on peak usage time intervals for a power grid.

13. A system for charging and discharging batteries comprising:
a charging server that:
predicts a peak recharge time interval for charging points of charging stations based on state of charge (SoC) data for electric vehicles (EVs) that are within a threshold distance, wherein the SoC data characterizes an SoC of batteries of the EVs;
determines, in response to the prediction of the peak recharge time interval, a charge time for the charging points of the charging stations, wherein the charge time defines a time to charge a respective battery of the charging points prior to the predicted peak recharge time interval;
creates and/or updates charging schedules for the charging points of the charging stations based on the charge time and the peak recharge time interval for the charging points of the charging stations; and
computing platforms of the charging points of the charging stations that:
receive a respective charging schedule of the charging schedules;
determines, in response to the prediction of the peak recharge time interval characterized in the charging schedules, a charge time for the charging points of the charging stations, wherein the charge time defines a time to charge a respective battery of the charging points prior to the predicted peak recharge time interval; and
control operations of an inverter and an alternating current (AC) to direct current (DC) converter to charge and discharge a respective battery according to the respective charging schedule.

14. The system of claim 13, wherein the peak recharge time interval for a particular charging station of the charging stations is a time interval where at least 70% of charging points at the particular charging station are expected to be coupled to a respective EV of the EVs.

15. The system of claim 13, wherein the server comprises a machine learning (ML) model tuned with the SoC data.

16. The system of claim 15, wherein the prediction of the peak recharge time interval for a particular charging station of the charging stations is based on a calculated likelihood that a subset of the EVs will recharge at the particular charging station.

17. The system of claim 13, wherein the charging server predicts a total available power for a power grid as a function of time based on the SoC data and the peak recharge time.

18. A method for charging and discharging batteries comprising:
predicting, by a charging server, a peak recharge time interval for charging points of charging stations based on state of charge (SoC) data for electric vehicles (EVs) that are within a threshold distance, wherein the SoC data characterizes an SoC of batteries of the EVs;
creating and/or updating, by the charging server, charging schedules for the charging points of the charging stations based on the charge time and the peak recharge time interval for the charging points of the charging stations;
receiving, at computing platforms operating on the charging points of the charging stations, a respective charging schedule of the charging schedules;
determining, by the computing platforms, a charge time for the charging points of the charging stations based on corresponding predicted peak recharge time intervals for the charging stations characterized in the charging schedules, wherein the charge time defines a time to charge a respective battery of the charging points prior to the predicted peak recharge time interval; and
controlling, by the computing platforms, operations of the respective charging points to charge and discharge a respective battery according to the respective charging schedule.

19. The method of claim 18, wherein the prediction of the peak recharge time interval for a particular charging station of the charging stations is based on a calculated likelihood that a subset of the EVs will recharge at the particular charging station.

20. The method of claim 19, further comprising predicting, by the charging server, a low usage time period for a particular charging station of the charging stations, and the charge control module creates and/or updates a respective charging schedule of the charging schedules based on the low usage period of time, and a computing platform of charging points of the particular charging station causes a corresponding battery to discharge to at or below a threshold charge level until the low usage period of time has expired.
